(19) United States
(12) Patent Application Publication
(10) Pub. No.: US 2024/0092481 A1
(43) Pub. Date: Mar. 21, 2024

(54) CERAMIC PROPELLER

(71) Applicant: HYDRONALIX, INC., Green Valley, AZ (US)

(72) Inventors: Anthony C. Mulligan, Sahuarita, AZ (US); Lloyd Vincent Mulligan, Green Valley, AZ (US); Jaime Lara-Martinez, Tucson, AZ (US); Jay M. Cohen, Virginia Beach, VA (US); Drey Dean Platt, Sahuarita, AZ (US); Dylan Kylar Allen Gutierrez, Tucson, AZ (US); Eva Marie Huie, Tucson, AZ (US); Robert W. Lautrup, Oakton, VA (US); Ronald A. Cipriani, Green Valley, AZ (US)

(21) Appl. No.: 17/932,929

(22) Filed: Sep. 16, 2022

(51) Int. Cl. B63H 1/20; B63G 8/00; B63G 8/08; B63H 1/26; B64C 11/20; B64C 39/02

(52) U.S. Cl. CPC B63H 1/20; B63G 8/001; B63G 8/08; B63H 1/26; B64C 11/20; B64C 39/024; B63G 2008/005; B64C 2201/108

(57) ABSTRACT

A propeller according to an embodiment includes a hub and a series of blades extending outward from the hub. Each blade of the series of blades includes a core and a skin covering the core. The core may be formed of a ceramic first material and the skin is formed of a second material different than the ceramic first material. The ceramic first material of the core may be ceramic Si₃N₄ (silicon nitride), yttria-toughened zirconia ceramic, or alumina-zirconia ceramic, and the second material of the skin may be a polymer. The polymer skin is configured to function as a shock absorber protecting the ceramic core, and the ceramic core is configured to provide rigidity to maintain the shape of the propeller blades under aerodynamic loading, which enables improved aerodynamic efficiency and reduced noise generation.

### STATEMENT REGARDING FEDERALLY SPONSORED RESEARCH OR DEVELOPMENT

This invention was made with U.S. Government support under contract No. N68335-21-C-0728 awarded by the U.S. Navy. The U.S. Government has certain rights in the invention.

### BACKGROUND

### 1. Field

The present disclosure relates to various embodiments of a propeller and a vehicle including a propeller.

### 2. Description of the Related Art

Related art propellers are typically formed of polymers, such as nylon or acrylonitrile butadiene styrene (ABS), which are relatively lightweight, strong, and damage tolerant. Some related art propellers incorporate short glass fibers oriented lengthwise along the axis of the propeller blades to increase the stiffness of the blades. Related art propellers with glass fibers may be formed using pultrusion to orient the glass fibers along the length of the blades.

However, related art propellers formed of these materials must be relatively thick to achieve the require strength (e.g., tensile strength, flexural strength, and flexural modulus), which increases the weight and the acoustics (e.g., radiated noise) of the propeller, and reduces the aerodynamic performance and efficiency of the propeller by increasing drag and the incidence of cavitation, which may damage the propeller and the vehicle on which the propeller is incorporated. For instance, some related art propellers for small unmanned aerial system (UAS) drones have an efficiency of only approximately 16% to approximately 30%.

### SUMMARY

The present application relates to various embodiments of a propeller. In one embodiment, the propeller includes a hub and a series of blades extending outward from the hub. Each blade of the series of blades includes a core including a ceramic first material.

The ceramic first material of the core may be ceramic Si₃N₄ (silicon nitride), yttria-toughened zirconia ceramic, and/or alumina-zirconia ceramic.

The core may also include a series of discontinuous filaments embedded in the ceramic first material and oriented along an axial direction of the respective blade. Each blade of the plurality of blades may further include a skin covering the core,

the skin including a second material different than the ceramic first material. The second material of the skin may be a polymer.

A maximum thickness of the core may be in a range from approximately 65% to approximately 85% of a maximum thickness of the blade. A maximum thickness of the core may be at least approximately 75% of a maximum thickness of the blade.

A thickness of the skin may be in a range from approximately 7.5% to approximately 17.5% of the maximum thickness of the blade. A thickness of the skin may be approximately 12.5% of the maximum thickness of the blade.

A ratio of a tip thickness to a chord length at a tip of each blade may be approximately 6% or less.

The propeller may be made completely of the ceramic first material.

The present application also relates to various embodiments of a vehicle. In one embodiment, the vehicle includes a body, a propeller rotatably coupled to the body, and a power supply housed in the body and electrically connected to the propeller. The propeller includes a hub and a series of blades extending outward from the hub. Each blade of the series of blades includes a core including a ceramic first material.

The vehicle may be an aerial vehicle or a maritime vessel, such as an unmanned underwater vehicle (UUV), an unmanned surface vehicle (USV), or a remotely operated underwater vehicle (ROV). The propeller may be a propulsor of the maritime vessel.

The ceramic first material of the core may be ceramic Si₃N₄ (silicon nitride), yttria-toughened zirconia ceramic, and/or alumina-zirconia ceramic. The second material of the skin may be a polymer.

The core may also include a series of discontinuous filaments embedded in the ceramic first material and oriented along an axial direction of the respective blade.

Each blade of the plurality of blades may further include a skin covering the core, the skin including a second material different than the ceramic first material. The second material of the skin may be a polymer.

A maximum thickness of the core may be in a range from approximately 65% to approximately 85% of a maximum thickness of the blade.

A thickness of the skin may be in a range from approximately 7.5% to approximately 17.5% of the maximum thickness of the blade.

A ratio of a tip thickness to a chord length at a tip of each blade of the plurality of blades may be approximately 6% or less. The power supply may be configured to rotate the propeller at a rotational rate in

a range from approximately 6,000 revolutions per minute (rpm) to approximately 12,000 rpm, and a diameter of the propeller may be in a range from approximately 3 inches to approximately 16 inches.

The propeller may have an aerodynamic efficiency in a range from approximately 50% to approximately 80%.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features may be combined with one or more other described features to provide a workable device.

### BRIEF DESCRIPTION OF THE DRAWINGS

These and other features and advantages of embodiments of the present disclosure will become more apparent by reference to the following detailed description when considered in conjunction with the following drawings. In the drawings, like reference numerals are used throughout the figures to reference like features and components. The figures are not necessarily drawn to scale.

FIG. 1 is a perspective view of a vehicle including a propeller according to one embodiment of the present disclosure;

FIGS. 2A-2C are a perspective view with partial breakaway, a top view, and a side view, respectively, of the propeller according to the embodiment illustrated in FIG. 1;

FIG. 3 is a graph depicting the tip speed (in Mach number) of the blades as a function of the diameter of the propeller and the rotational rate (in RPMs) of the propeller; and

FIG. 4 is a diagram depicting the critical Mach number as a function of the tip thickness and camber of the embodiment of the propeller illustrated in FIGS. 2A-2C.

### DETAILED DESCRIPTION

The present disclosure relates to various embodiments of a propeller, and an aerial vehicle incorporating the propeller, having a ceramic core and a polymer skin covering the ceramic core. The propeller of the present disclosure is formed of a higher strength and higher modulus material than conventional propellers formed of nylon, glass filled nylon, or APC fiber composite. Utilizing stronger materials for the propeller enables the propeller to be thinner than propellers formed of conventional materials, which reduces the weight of the propeller and increases the aerodynamic efficiency of the propeller (e.g., reduced drag and cavitation during operation). When the propeller is incorporated into a vehicle, the propeller enables greater operational duration (e.g., flight time) and greater range due to reduced power consumption (e.g., greater fuel efficiency) achieved by the reduced weight and increased aerodynamic efficiency of the propeller (e.g., approximately 50% to approximately 80% aerodynamic efficiency). Additionally, utilizing higher modulus materials for the propeller increases the stiffness of the propeller compared to conventional propellers, which enables greater control of the vibration resonance response of the propeller (e.g., the natural frequency of the propeller may be controlled to preclude excitation of the propeller from engine torsional vibration and aero-elastic flutter, which might otherwise result in catastrophic failure of the propeller). The propellers of the present disclosure are also configured to reduce radiated noise from the propeller (e.g., a 10-12 dB average reduction in radiated noise).

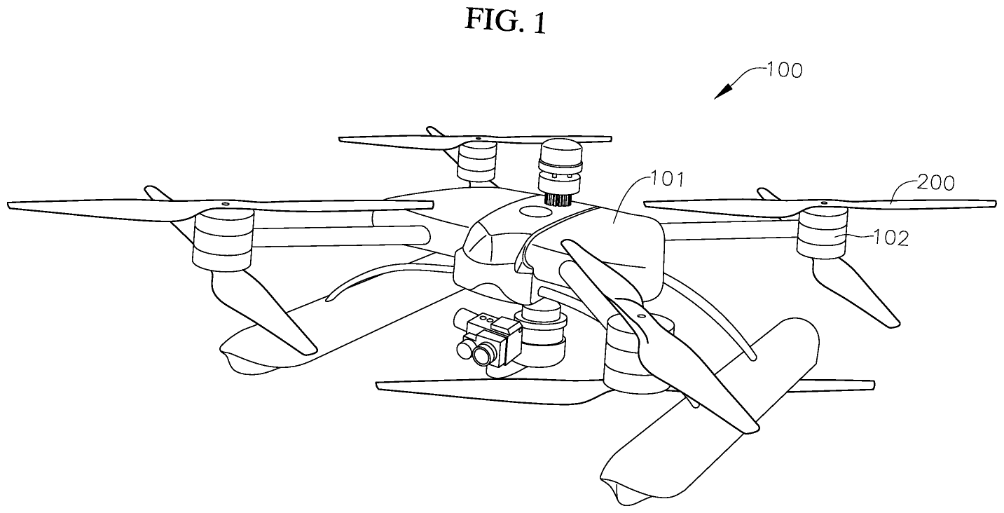

With reference now to FIG. 1, a vehicle 100 according to one embodiment of the present disclosure includes a body (e.g., a hull) 101, a power source 102 (e.g., a battery coupled to an electric motor) coupled to the body 101, and at least one propeller 200 coupled to the body 101 and configured to be rotatably driven by the power source 102. The vehicle 100 may be any suitable type or kind of vehicle, such as an aerial vehicle (e.g., an unmanned aerial vehicle (UAV)) or a maritime vessel (e.g., an unmanned underwater vehicle (UUV), an unmanned surface vehicle (USV), or a remotely operated underwater vehicle (ROV)). Additionally, in one or more embodiments, the vehicle 100 may be any suitable type or kind of an aerial vehicle, such as an aerial vehicle incorporating a variable pitch propeller (e.g., quad-copters) or an aerial vehicle incorporating a fixed pitch propeller (e.g., the Predator, Shadow, Scan Eagle, Aerosonde, other electric UAVs, or a small tactical unmanned aerial system (STUAS) type vehicle). In one or more embodiments, the vehicle 100 may be the aerial vehicle described in U.S. patent application Ser. No. 17/329,965, filed May 25, 2021, the entire content of which is incorporated herein by reference, and the vehicle 100 may include four pairs of upper and lower propellers 200. Further, as described above, the vehicle 100 may be a maritime vessel (e.g., an unmanned underwater vehicle (UUV), an unmanned surface vehicle (USV), or a remotely operated underwater vehicle (ROV)), such as a vehicle described in U.S. patent application Ser. No. 16/858,446, filed Apr. 24, 2020, the entire content of which is incorporated herein by reference, and the aspects described herein with respect to the at least one propeller 200 may be applied to at least one propulsor of the maritime vehicle.

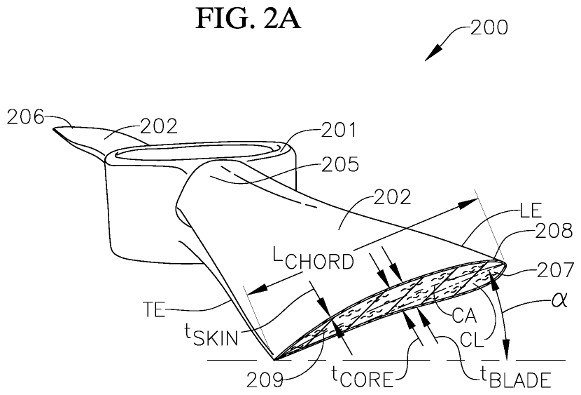

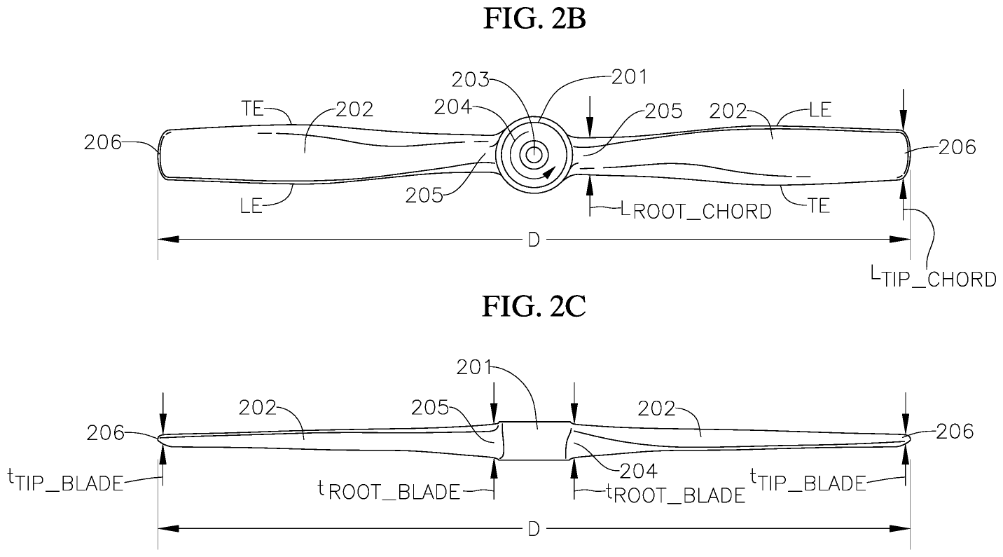

With reference now to the embodiment illustrated in FIGS. 2A-2C, the propeller 200 includes a hub 201 and a series of blades 202 extending outward (e.g., radially outward) from the hub 201. The hub 201 may house one or more components 203 (e.g., a drive sleeve or a splined bearing) configured to enable the propeller 200 to be coupled to a drive shaft of a motor that is configured to drive (i.e., rotate) the propeller 200. Although in the illustrated embodiment the propeller 200 includes two blades 202, in one or more embodiments the propeller 200 may include any other suitable number of blades 202, such as three blades, four blades, or more. The propeller 200 may have any diameter D suitable for the vehicle 100 into which the propeller 200 is incorporated and the desired performance characteristics (e.g., payload capacity, range, flight ceiling, speed, etc.), such as a diameter D in a range from approximately 3 inches to approximately 16 inches. In one or more embodiments, the diameter D of the propeller 200 may be in a range from approximately 5 inches to approximately 12 inches. In the illustrated embodiment, each blade 202 of the propeller 200 includes a leading edge LE and a trailing edge TE opposite the leading edge LE. For each of the blades 202, the leading edge LE is configured to contact the fluid (e.g., air or water) before the trailing edge TE when the propeller 200 is rotated (arrow 204) about the centerline of the hub 201. Each of the blades 202 also includes a chord line CL defined along a straight line extending from the leading edge LE to the trailing edge TE. Each blade 202 of the propeller 200 also includes a camber line CA bisecting a center of the blade 202 (i.e., a mean camber line CA equidistantly spaced between an upper surface (or upper camber) and a lower surface (or lower camber) of the blade 202). The distance between the camber line CA and the chord line CL defines the extent of the camber of the blades 202 (i.e., the greater the distance between the camber line CA and the chord line CL, the greater the camber of the blades 202). In the illustrated embodiment, each of the blades 202 extends from a root section or portion 205 proximate to the hub 201 to a tip section or portion 206 distal to the hub 201. In the illustrated embodiment, the root portion 205 of each of the blades 202 has a first thickness tROOLBLADE, and the tip portion 206 of each of the blades 202 has a second thickness t_{TIP_BLADE} less than the first thickness t_{ROOT_BLADE}. Additionally, in one or more embodiments, a length L_{CHORD} of the chord line CL may vary along the length of the blades 202. For instance, in one or more embodiments, a length L_{ROOT_CHORD} of the chord CL of the blades 202 at the root portion 205 may be longer than a length L_{TIP_CHORD} of the chord CL of the blades 202 at the tip portion 206. Further, in the illustrated embodiment, each of the blades 202 may be angled at an angle of attack a (i.e., the leading edge LE of the blades 202 may be pitched upward such that chord line CL of the blades 202 are angled relative to a plane in which the blades 202 rotate (arrow 204)). Additionally, in one or more embodiments, the angle of attack a may be constant or substantially constant along the length of the blades 202. In one or more embodiments, the angle of attack a may vary along the length of the blades 202 (e.g., the angle of attack a of the blades 202 may increase from the root portion 205 to the tip portion 206). In one or more embodiments, each of the blades 202 may have an airfoil shape (e.g., a NACA airfoil shape) in a cross-section. Additionally, in one or more embodiments, the propeller 200 may be a scimitar propeller (as known as a “prop-fan” or an un-ducted fan (UDF)) in which the sweep of the leading edges LE of the blades 202 increases in a direction from the hub 201 to the tips 206 of the blades 202 (i.e., the leading edges LE of the blades may be swept backward toward the trailing edges TE). In general, scimitar propellers are configured to have greater aerodynamic efficiency and generate less noise than otherwise similar propellers.

Additionally, in the illustrated embodiment, each blade 202 of the propeller 200 includes a skeleton or a core 207 and a skin 208 covering the core 207. In one or more embodiments, the core 207 of each blade 202 is formed of a ceramic material (e.g., ceramic Si₃N₄ (silicon nitride), yttria-toughened zirconia ceramic, and/or alumina-zirconia ceramic), and the skin 208 is formed of a polymer material. The skin 208 is impact resistant and is configured to protect the ceramic core 207 (e.g., protect the ceramic core 207 against damage from objects striking the propeller 200 during takeoff and landing and against rain or hail striking the propeller 200 during flight), and the ceramic core 207 provides rigidity to maintain the shape of the propeller blades 202 under aerodynamic loading, the significance of which is described in detail below. Table 1 below illustrates the tensile strength (ksi), tensile strain (%), flexural strength (ksi), and flexural modulus (Msi) of the blades 202 of the propeller 200 based on the ceramic material of the core 207. In one or more embodiments, the core 207 of each blade 202 of the propeller 200 may be monolithic (e.g., the core 207 may include only a ceramic material, such as ceramic Si₃N₄ (silicon nitride), yttria-toughened zirconia ceramic, and/or alumina-zirconia ceramic). In one or more embodiments, the core 207 of each blade 202 of the propeller 200 may include a ceramic material (e.g., ceramic Si₃N₄ (silicon nitride), yttria-toughened zirconia ceramic, and/or alumina-zirconia ceramic) embedded with high modulus carbon fibers 209 (e.g., discontinuous filaments) aligned along (or substantially along) an axial direction of the blade 202. The inclusion of the carbon fibers 209 is configured to provide high tensile strength. The individual carbon fibers 209 may have any suitable diameter, such as a diameter in a range from approximately 8 microns to approximately 12 microns (e.g., approximately 10 microns). In another embodiment, each blade 202 of the propeller 200 may consist entirely of the ceramic skeleton or core 207 (with or without the carbon fibers). That is, the skin 208 may be omitted. Further, the hub 201 may be made of the same material as the blades 202. For example, the hub 201 may be made of a core and a skin, or only a core, as described above with respect to the blades 202. In an embodiment, the propeller 200 may be made completely of any of the above-described ceramic materials. Further, in an embodiment, the hub 201 and the blades 202 may be integrally formed of the same material or materials. However, embodiments are not limited thereto. For example, the hub 201 may be made of a ceramic material, a polymer, wood, or a metal, for example, and may be made of a material different from the blades 202.

TABLE 1

| | Tensile | Tensile | Flexural | Flexural |
|---|---|---|---|---|
| | strength | strain | strength | modulus |
| Property | (ksi) | (%) | (ksi) | (Msi) |
| Ceramic Si3N4 | 52.0 | 0.1 | 88.2 | 36.8 |
| Yttria toughened Zirconia | 40.0 | 0.1 | 65.0 | 32.0 |

| | | |
|---|---|---|
| C_{(f)} low-mod | 357.0 (tensile mod. 26.3 Msi) | High but matrix dependent |
| C_{(f)} high-mod | 900.0 (tensile mod. 44.6 Msi) | Higher but matrix dependent |

In contrast, Table 2 below lists the tensile strength (ksi), tensile strain (%), flexural strength (ksi), and flexural modulus (Msi) of the blades of the propeller that are formed of conventional materials.

TABLE 2

| | Tensile | Tensile | Flexural | Flexural |
|---|---|---|---|---|
| | strength | strain | strength | modulus |
| Property | (ksi) | (%) | (ksi) | (Msi) |
| Nylon | 11.0 | Large | 7.0 | 0.41 |
| Glass filled nylon | 18.0 | 3.5 | 29.0 | 1.3 |
| APC Fiber | 24.0 | 6 | 38.0 | 2.3 |
| composite | | | | |

Accordingly, as illustrated in Table 1 and Table 2 above, the blades 202 of the propeller 200 according to various embodiments of the present disclosure have an increased flexural modulus (bending modulus) compared to an otherwise identical propeller formed of conventional materials. For instance, the propeller 200 of the present disclosure having the core 207 formed of ceramic Si₃N₄ (silicon nitride) has a flexural modulus of 36.8 million pounds per square inch (Msi), whereas an otherwise equivalent propeller formed of nylon has a flexural modulus of 0.41 Msi. Additionally, the propeller 200 of the present disclosure having the core 207 formed of yttria toughened zirconia has a flexural modulus of 32.0 Msi, whereas an otherwise equivalent propeller formed of APC fiber composite has a flexural modulus of 2.3 Msi. Thus, a propeller 200 according to various embodiments of the present disclosure has a flexural modulus that is in a range between approximately 16 and approximately 89 times greater than the conventional propeller.

The increased stiffness (bending modulus) and strength of the propellers 200 of the present application compared to conventional propellers enables the propellers 200 of the present application to be thinner than conventional propellers, which reduces the weight of the propeller 200 and increases the aerodynamic performance and efficiency of the propeller. For instance, the reduction in thickness of the blades 202 of the propeller 200 reduces the drag generated by the propeller 200 and mitigates or prevents cavitation when the propeller 200 is operated in water (i.e., when the propeller 200 is operated in water, the reduction in thickness of the blades 202 of the propeller 200 mitigates against the formation of vapor-filled cavities in the water, which tend to collapse and generate shock waves that can damage the propeller 200 and/or other components of the vehicle 100). The reduction in thickness of the blades 202, which is enabled by the increased stiffness and strength of the blades 202, results in increased duration and range of the vehicle 100 incorporating the propeller 200 compared to a vehicle incorporating a conventional propeller. For instance, a drone (e.g., the Navy Coyote-Locust UAS) incorporating a conventional propeller may have a maximum flight duration of approximately 34 minutes, whereas the same drone incorporating the propeller 200 of the present disclosure may have a maximum flight duration of approximately 60 minutes. Accordingly, in one or more embodiments, an aerial vehicle switching from a conventional propeller to a propeller of the present disclosure may increase aerodynamic efficiency to approximately 50% to approximately 80% without any additional modifications to the aerial vehicle (i.e., the propellers 200 of the present disclosure may be approximately 50% to approximately 80% efficient in converting rotational blade movement into thrust). Moreover, a small tactical fuel-powered UAV (e.g., the Scan Eagle or Shadow) with a conventional propeller may have a range of approximately 100 miles per gallon of fuel, whereas the same small tactical fuel-powered UAV with a propeller 200 of the present disclosure may have a range of approximately 150 miles or more per gallon of fuel.

The high modulus of the propeller 200 also provides a high resistance to bending, thereby maintaining the designed optimal shape (i.e., resists deformation and thereby maintains the aerodynamic profile or contour) of the propeller 200 during flight, which improves the aerodynamic efficiency of the propeller 200 compared to conventional propellers that are prone to bending under aerodynamic loads. Additionally, in one or more embodiments, the high modulus material(s) of the propeller 200 may be selected such that the blades 202 of the propeller 200 are impact resistance (e.g., resistant to damage from objects striking the propeller 200 during takeoff and landing and resistant to rain or hail striking the propeller 200 during flight).

A reduction in thickness t_{BLADE} of the blades 202, which is enabled by the increased stiffness and strength of the blades 202, also results in a reduction in radiated noise from the propeller 200 compared to conventional propellers. For instance, the propellers 200 of the present disclosure may generate radiated noise that is in a range between approximately 10 decibels (dB) and approximately 12 dB less than conventional propellers that are otherwise comparable. Accordingly, a vehicle (e.g., an aerial or maritime vehicle) switching from a conventional propeller (i.e., a propeller formed of nylon or glass filled nylon) to a propeller 200 of the present disclosure may result in a reduction in radiated noise that is in a range between approximately 10 dB and approximately 12 dB.

Additionally, the increased stiffness of the propellers 200 of the present application compared to conventional propellers enables greater control of the vibration resonance response of the propellers 200 of the present disclosure. For instance, the increased stiffness of the blades 202 of the propeller 200 results in the natural frequency of the blades 202 being higher than the torsional vibration from the power source 102 (e.g., the engine or motor) of the vehicle 100, and higher than the frequency of aero-elastic flutter of the blades 202 when the vehicle 100 incorporating the propeller 200 is operated (e.g., driven or flown). Otherwise, excitation of the blades 202 at their natural frequency may result in catastrophic failure of the blades 202.

In one or more embodiments, a maximum thickness tcoRE of the core 207 is in a range from approximately 65% to approximately 85% of the maximum thickness t_{BLADE} of the blade 202 (e.g., the maximum thickness tcoRE of the core 207 is in a range from approximately 65% to approximately 85% of the combined thickness t_{CORE} of the core 207 and twice a thickness t_{SKIN} of the skin 208). In the illustrated embodiment, a maximum thickness t_{CORE} of the core 207 is approximately 75% of the maximum thickness t_{BLADE} of the blade 202 (e.g., the maximum thickness tcoRE of the core 207 is approximately 75% of the combined thickness t_{CORE} of the core 207 and twice the thickness t_{SKIN} of the skin 208). Additionally, in one or more embodiments, the thickness tsKIN of the skin 208 is in a range from approximately 7.5% to approximately 17.5% of the maximum thickness t_{BLADE} of the blade 202 (e.g., the thickness t_{SKIN} of the skin 208 is in a range from approximately 7.5% to approximately 17.5% of the combined thickness t_{core} of the core 207 and twice the thickness t_{SKIN} of the skin 208). In the illustrated embodiment, the thickness t_{SKIN} of the skin 208 is approximately 12.5% of the maximum thickness t_{blade} of the blade 202 (e.g., the thickness t_{SKIN} of the skin 208 is approximately 12.5% of the combined thickness t_{CORE} of the core 207 and twice the thickness t_{SKIN} of the skin 208).

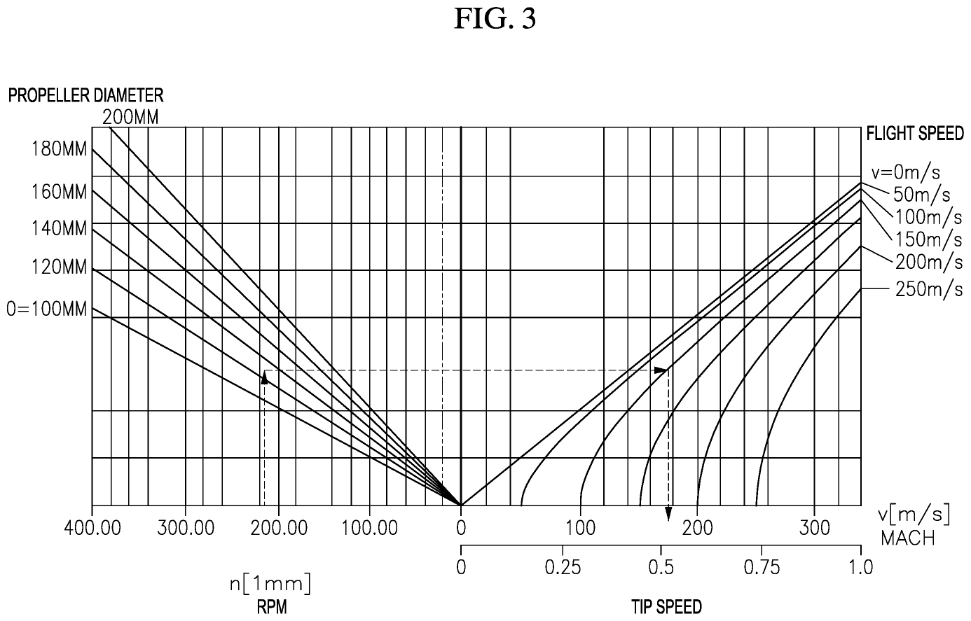

The Mach speed of the tips 206 of the blades 202 at which the fluid flow reaches supersonic speed at any point over the blades 202 is known as the “critical Mach number.” In one or more embodiments, the blades 202 of the propeller 200 may be configured to prevent supersonic flow over the blades 202 for a given rotational speed of the tips 206. In general, it is desirable to prevent supersonic flow over the blades 202 to avoid excessive drag and cavitation, although in some circumstances it may be acceptable to have a small supersonic region at the tips 206 of the blades 202 because a reduction in diameter D of the propeller 200 to avoid this supersonic region also decreases aerodynamic performance. FIG. 3 is a graph depicting the tip speed (in Mach number) of the blades 202 as a function of the diameter D of the propeller 200, the rotational rate (in RPMs) of the propeller 200, and the flight speed of the vehicle 100.

The speed of the blades 202 at the tips 206 may also be calculated by first calculating the propeller tip speed Vᵣ due to rotation of the propeller 200 alone according to Equation 1 as follows:

Vᵣ=0.00010472*RPM*R, units of m/s (Equation 1)

where RPM is the revolutions per minute of the propeller 200 and R is the radius of the propeller 200 in millimeters. When the aerial vehicle 100 incorporating the propeller 200 is flying at velocity V, the speed of the fluid (e.g., air) over the propeller tips 206 is above the propeller tip speed Vᵣ due to rotation of the propeller 200 alone. The “helical” speed of the propeller tips 206 in flight Vₜᵢₚ (which is the actual speed of the propeller tips 206 due to both the rotation of the propeller 200 and the velocity V at which the aerial vehicle 100 is flying) is calculated according to Equation 2 as follows:

Vₜᵢₚ=\sqrt{Vᵣ²+V²}, units of m/s (Equation 2)

The Mach number M of the propeller tips 206 may then be calculated according to

Equation 3 as follows:

$$M = \frac{{V}_{tip}}{{M}_{0}} , non - dimentional \qquad ( Equation 3 )$$

where M₀is the speed of sound, which may be calculated according to Equation 4 as follows:

M₀=0.594*T+325.56 (Equation 4)

where T is the air temperature in degrees Centigrade (° C.).

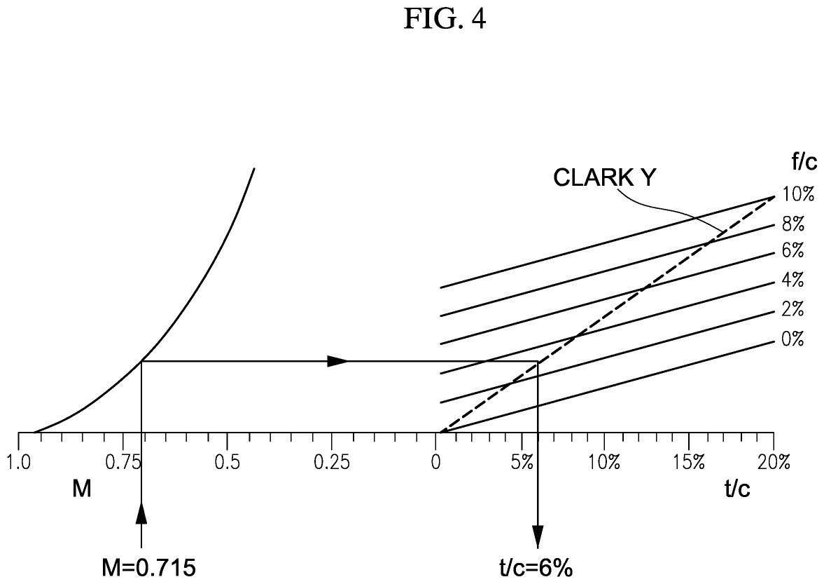

FIG. 4 is a diagram showing the association between the critical Mach number and the airfoil geometry of the blades 202. That is, FIG. 4 shows the maximum allowable ratio of thickness t_{TIP_BLADE} to chord length L_{TIP_CHORD} (t/c) at the tips 206 of the blades 202 for a given Mach number at the tips 206 of the blades 202 such that the fluid flow over the blades 202 does not reach supersonic speed. FIG. 4 also depicts the maximum Mach number at the tips 206 of the blades 202 such that the fluid flow over the blades 202 does not reach supersonic speed for a given ratio of thickness t_{TIP_BLADE} to chord length L_{TIP_CHORD} (t/c) at the tips 206 of the blades 202. Accordingly, the thickness t_{TIP_BLADE} and the chord length L_{TIP_CHORD} of the blades 202 at the tips 206, as well as the rotational speed of the propeller 200, may be selected such that supersonic fluid flow does not occur over the blades 202.

It is generally accepted that when a propeller is operated such that the speed of propeller tips is above Mach 0.7, the noise produced by the propeller at the propeller tips starts to increase rapidly and the lift begins to decrease rapidly. Accordingly, in one or more embodiments, the propellers 200 of the present disclosure may be operated such that the speed of the propeller tips 206 is below Mach 0.7. In one or more embodiments, the propellers 200 of the present disclosure may be operated in a range from approximately 6,000 rpms to approximately 12,000 rpms. According to FIG. 3 and Equations 1-4 above, in one or more embodiments in which the diameter D of the propeller is 12 inches (304.8 mm), the speed V r of the propeller tips 206 is Mach 0.22 when the propeller 200 is operated at 6,000 rpms and the speed of the propeller tips 206 is Mach 0.45 when the propeller 200 is operated at 12,000 rpms, and thus the entire operational envelope of the propeller 200 is below the Mach 0.7 threshold at which the noise generated from the propeller tips 206 increases rapidly and the thrust generated by the propeller tips 206 decreases rapidly.

According to FIG. 4, in one embodiment of the present disclosure in which the propeller 200 is operated such that the speed V tip of the propeller tips 206 is Mach 0.715, the blades 202 of the propeller 200 may have a ratio of thickness t_{TIP_BLADE} to chord length L_{TIP_CHORD} (t/c) at the tips 206 up to approximately 6% (e.g., t/c may be in a range from approximately 4% to approximately 6%). Accordingly, in an embodiment in which the blades 202 of the propeller 200 have a chord length L_{TIP_CHORD} at the tips 206 of approximately 0.5 in (approximately 12.7 mm), the thickness t_{TIP_BLADE} of the blades 200 at the tips 206 may be up to approximately 0.030 in (e.g., the tip thickness t_{TIP_BLADE} of the blades 202 may be in a range of approximately 0.020 in (to achieve a t/c of 4%) and approximately 0.030 in (to achieve a t/c of 6%)). However, in one or more embodiments, the propeller 200 may be configured to generate a supersonic region at the propeller tips 206 for an intended rotational rate of the propeller 200 (e.g., if the reduction in performance due to the supersonic region at the tips 206 is less than the reduction in performance due to an increase in the thickness, an increase in chord length LCHORD, and/or a reduction in camber CA necessary to prevent the formation of supersonic region at the propeller tips 206).

The propellers 200 of the present disclosure may be manufactured in any suitable manner and with any suitable techniques, such as additive manufacturing (i.e., 3D printing). In one embodiment, the skeleton or core 207 of the blades 202 may be formed by robocasting a highly loaded ceramic slurry (e.g., alumina or yttria) into a near-net desired aerodynamic shape of the blades 202. In one or more embodiments, the core or skeleton 207 of each blade 202 of the propeller 200 may be formed by ceramic gel-casting (i.e., a ceramic gel-casting slurry may be cast into a mold having the desired aerodynamic shape of the blades 202), slip-casting, or injection molded to net shape and then sintered in an air furnace to net shape at relatively low temperatures, which provides good surface finishes. Additionally, in one or more embodiments, carbon fibers may be laid up inside the mold or other industrial tooling with minimal fibers in the warp directions to hold the axially-oriented fibers in place such that the carbon fibers 209 are embedded in the ceramic material of the core 207 and aligned (or substantially aligned) with the axial direction of the blades 202 following the task of molding the ceramic material and the carbon fibers. In one or more embodiments, a matrix material, such as a high strength polyether ether ketone (PEEK) polymer material, may be utilized.

In one or more embodiments, the task of forming the ceramic core 207 of the blades 202 includes free forming a billet of directionally aligned discontinuous filament-reinforced acrylonitrile butadiene styrene (abs) or nylon material. The discontinuous filaments may be aligned or substantially aligned parallel (or substantially parallel) to the stress fields of the propeller 200 under aerodynamic loading. The near net shape billet may then be put on a 5-axis computer numerical control (CNC) machine and machined to the final dimensions. In one or more embodiments, this process is accurate to a tolerance of about 0.005 inch, and therefore the blades 202 of the propeller 200 may require post-machining to the final dimensions and tolerances. In one or more embodiments, the near net-shape blades 202 of the propeller 200 may be loaded into a precision mold for tolerance and surface finishing.

In another embodiment, the task of forming the ceramic core 207 of the blades 202 includes utilizing a 5-axis CNC machine to fabricate a precision mold having the desired configuration of the blades 202, and then performing hand lay-up of unidirectional carbon fiber pre-preg tows (i.e., a fiber bundle that is pre-impregnated with resin) in the mold to achieve the desired shape of the blades 202.

The ceramic skeleton or core 207 (with or without the carbon fibers) may then be loaded into a mold and then a polymer (e.g., nylon 66) may then be cast around the ceramic core to form the polymer skin 208. In one or more embodiments, the polymer utilized to form the polymer skin 208 may be a room-temperature castable zero shrinkage (or substantially zero shrinkage) nylon 66 compound developed by Advanced Ceramics. As described above, the polymer skin 208 provides the final dimension tolerance for the blades 202 of the propeller 200 and the aerodynamic surface finish as well as a shock absorber protecting the ceramic core 207, whereas the ceramic core 207 provides rigidity to maintain the shape of the propeller blades 202 under aerodynamic loading and enables improved aerodynamic efficiency and reduced noise generation.

While this invention has been described in detail with particular references to exemplary embodiments thereof, the exemplary embodiments described herein are not intended to be exhaustive or to limit the scope of the invention to the exact forms disclosed.

Persons skilled in the art and technology to which this invention pertains will appreciate that alterations and changes in the described systems and methods of operation can be practiced without meaningfully departing from the principles, spirit, and scope of this invention, as set forth in the following claims, and equivalents thereof.

What is claimed is:

1. A propeller comprising:
a hub; and
a plurality of blades extending outward from the hub, each blade of the plurality of blades comprising a core comprising a ceramic first material.

2. The propeller of claim 1, wherein the ceramic first material of the core is selected from the group consisting of ceramic Si₃N₄ (silicon nitride), yttria-toughened zirconia ceramic, and alumina-zirconia ceramic.

3. The propeller of claim 1, wherein the core further comprises a plurality of discontinuous filaments embedded in the ceramic first material and oriented along an axial direction of a respective one of the plurality of blades.

4. The propeller of claim 1, wherein each blade of the plurality of blades further comprises a skin covering the core, the skin comprising a second material different than the ceramic first material.

5. The propeller of claim 4, wherein the second material of the skin is a polymer.

6. The propeller of claim 4, wherein a maximum thickness of the core is in a range from approximately 65% to approximately 85% of a maximum thickness of a respective one of the plurality of blades.

7. The propeller of claim 6, wherein the maximum thickness of the core is at least approximately 75% of the maximum thickness of the respective one of the plurality of blades.

8. The propeller of claim 6, wherein a thickness of the skin is in a range from approximately 7.5% to approximately 17.5% of the maximum thickness of the respective one of the plurality of blades.

9. The propeller of claim 8, wherein the thickness of the skin is approximately 12.5% of the maximum thickness of the respective one of the plurality of blades.

10. The propeller of claim 1, wherein a ratio of a tip thickness to a chord length at a tip of each blade of the plurality of blades is approximately 6% or less.

11. The propeller of claim 1, wherein the propeller is made completely of the ceramic first material.

12. A vehicle comprising:
a body;
a propeller rotatably coupled to the body; and
a power supply housed in the body and electrically connected to the propeller,
wherein the propeller comprises:
a hub; and
a plurality of blades extending outward from the hub, each blade of the plurality of blades comprising a core comprising a ceramic first material.

13. The vehicle of claim 12, wherein the vehicle is a maritime vessel.

14. The vehicle of claim 13, wherein the maritime vessel is selected from the group consisting of an unmanned underwater vehicle (UUV), an unmanned surface vehicle (USV), and a remotely operated underwater vehicle (ROV).

15. The vehicle of claim 13, wherein the propeller is a propulsor of the maritime vessel.

16. The vehicle of claim 12, wherein the vehicle is an aerial vehicle.

17. The vehicle of claim 12, wherein the ceramic first material of the core is selected from the group consisting of ceramic Si₃N₄ (silicon nitride), yttria-toughened zirconia ceramic, and alumina-zirconia ceramic.

18. The vehicle of claim 12, wherein the core further comprises a plurality of discontinuous filaments embedded in the ceramic first material and oriented along an axial direction of a respective one of the plurality of blades.

19. The vehicle of claim 12, wherein each blade of the plurality of blades further comprises a skin covering the core, the skin comprising a second material different than the ceramic first material.

20. The vehicle of claim 19, wherein the second material of the skin is a polymer.

21. The vehicle of claim 19, wherein a maximum thickness of the core is in a range from approximately 65% to approximately 85% of a maximum thickness of a respective one of the plurality of blades.

22. The vehicle of claim 21, wherein a thickness of the skin is in a range from approximately 7.5% to approximately 17.5% of the maximum thickness of the respective one of the plurality of blades.

23. The vehicle of claim 12, wherein a ratio of a tip thickness to a chord length at a tip of each blade of the plurality of blades is approximately 6% or less.

24. The vehicle of claim 12, wherein the power supply is configured to rotate the propeller at a rotational rate in a range from approximately 6,000 revolutions per minute to approximately 12,000 revolutions per minute, and wherein a diameter of the propeller is in a range from approximately 3 inches to approximately 16 inches.

25. The vehicle of claim 24, wherein the propeller has an aerodynamic efficiency in a range from approximately 50% to approximately 80%.
